(19) United States
(12) Patent Application Publication
(10) Pub. No.: US 2025/0088372 A1
(43) Pub. Date: Mar. 13, 2025

(54) VERIFICATION METHOD AND VERIFICATION COMPUTER SYSTEM HAVING AN NFT- GENERATING DEVICE AND A VERIFICATION DEVICE

(71) Applicant: ETO GRUPPE TECHNOLOGIES GmbH, Stockach (DE)

(72) Inventor: Sharang Deepak PARNERKAR, Stockach (DE)

(21) Appl. No.: 18/727,261

(22) PCT Filed: Dec. 20, 2022
(86) PCT No.: PCT/EP2022/086983

§ 371 Date: Jul. 8, 2024

(30) Foreign Application Priority Data
Jan. 10, 2022 (DE) 10 2022 100 411.2

(51) Int. Cl. H04L 9/32; H04L 9/00

(52) U.S. Cl. CPC H04L 9/3263; H04L 9/50

(57) ABSTRACT

A verification method, in particular a computer-implemented verification method, in an asymmetric cryptography system with at least one entity to which a public key and a private key are assigned, is proposed, wherein in at least one method step at least one non-fungible token (NFT) is created (minted) which contains a copy of the public key or a deterministic derivative of the public key and which is stored in a distributed ledger, such as a blockchain, a tangle or a hashgraph, of a distributed ledger technology (DLT).

### CROSS-REFERENCE TO RELATED APPLICATIONS

This patent application is a U.S. national stage application of international patent application PCT/EP2022/086983, filed on Dec. 20, 2022, which is based on and claims priority to German patent application DE 10 2022 100 411.2, filed on Jan. 10, 2022, the contents of which are incorporated herein by reference.

### PRIOR ART

The invention concerns a verification method, a verification computer system, an NFT creation device and a verification device.

While non-fungible tokens (NFT) are already enjoying great popularity in the crypto community, real technical applications outside the art market or the computer game market are still rare.

The objective of the invention is in particular to provide a generic method with advantageous properties in regard to digital verification and/or data security. The objective is achieved according to the invention.

### Advantages of the Invention

The invention is based on a verification method, in particular a computer-implemented verification method, in an asymmetric cryptography system with at least one entity to which a public key and a private key are assigned.

It is proposed that in at least one method step at least one non-fungible token (NFT) is created which contains a copy of the public key or a deterministic derivative of the public key and which is stored in a distributed ledger, such as a blockchain, a tangle or a hashgraph, of a distributed ledger technology (DLT). This advantageously enables simple and at the same time reliable verification of an authenticity of the public key. Advantageously, it is for example possible to replace a separate certification authority. In particular, the verification method is configured for a verification of an authenticity of the public key. “Configured” is in particular to mean specially programmed, designed and/or equipped. By an object being configured for a specific function is in particular to be understood that the object fulfils and/or executes this specific function in at least one application state and/or operation state. In particular, the verification method is executed with the aid of computers, in particular with the aid of operating programs stored on memories of the computers and executed by processors of the computers. An “asymmetric cryptography system” is in particular to mean a public key encryption and/or authentication system. In particular, in the asymmetric cryptography system each participant has at least one private key unknown to all further participants and a public key that is made public. Herein the public key enables everyone to encrypt data for the owner of the private key or to authenticate the owner of the private key. In particular, the public key is publicly available/accessible to anybody. The private key enables its owner to decrypt data encrypted with the associated public key or to authenticate himself. Advantageously, the proposed verification method is suitable for replacing public key infrastructures (PKI) based on digital certificates and certification authorities.

A non-fungible token (NFT), sometimes also called non-exchangeable token, is in particular to mean a digitized form of a dataset/asset which is preferably placed on a DLT, such as a blockchain or a tangle or the like, and which is in particular realized so as not to be one-to-one exchangeable, to be non-divisible and unique. NFTs are at least distributable and/or dispatchable within the DLT. In addition, it is conceivable that the DLTs are also capable of bridging the boundaries between different DLTs and are thus distributable and/or dispatchable between different DLTs. In public DLTs, the NFTs placed thereon, and preferably transactions associated with the NFT, can be viewed by anybody. An NFT can in particular be linked to at least one physical or digital object. Herein it is conceivable that an NFT is connected to several physical or digital objects (e. g. several public keys) and/or that an identical physical or digital object (e. g. a public key) is assigned to more than one NFT. In particular, the NFT created in the method step is at least linked to the digital object “public key”. For this purpose, the NFT comprises the public key or its deterministic derivative directly or in the form of a hash value of the public key or the like. As soon as the creation of the NFT comprising the public key or its deterministic derivative has been confirmed by the consensus protocol of the respective DLT, the assignment to the NFT is fixed in the DLT invariably and permanently (until possible redeeming or burning by an owner of the NFT). The creation of an NFT, in particular of an NFT connected to an object, is often also referred to as “minting” of the NFT. In particular, the NFT is generated by the entity itself, for example by means of a computer system of the entity which is connected to the DLT. Making ownership of the NFT impossible for anybody is often also referred to as “burning” of the NFT. Cancelation of the relationship between the NFT and the object assigned thereto is often also referred to as a “redeeming” of the NFT. In particular, the NFT can be created using a smallest possible unit of a DLT token. The DLT token realizes an underlying asset. For some applications, the underlying asset can also be increased, it may for example contain the actual value of the physical or digital object at the time of the creation, etc.

NFTs are preferably assigned to at least one, preferably exactly one, owner address within the DLT. This owner address assigned to the NFT may change by shipping, by an activity or by an exchange of the NFT. The DLT is preferably realized as a decentralized DLT. Alternatively, the DLT may also be realized in an only partially decentralized manner (distributed over few nodes) or in a centralized manner. The DLT is preferably realized as a publicly viewable DLT. Alternatively, it is conceivable that the DLT has at least one access restriction. Preferably, the NFT is publicly viewable via the DLT. Preferably, the owner address assigned to the NFT is publicly viewable via the DLT. Preferably, the assignment of the NFT to the owner address is publicly viewable via the DLT. A “deterministic derivative” of an object is in particular to mean a dataset/character sequence generated by the object and bijectively assignable to the object. For example, the deterministic derivative of the object is realized as a hash value of a digital object or of a digital image of a physical object. Alternatively, the deterministic derivative may be realized as a self-signed public key, etc.

Furthermore, it is proposed that authenticity of the public key is confirmed in that the NFT is owned by at least one legitimation entity that is different from the entity. This advantageously enables authenticity verification, in particular of the public key, in a simple and reliable manner. In particular, the authenticity of the public key is confirmed in that the NFT comprising the public key or its deterministic derivative is assigned within the DLT to a DLT owner address of the legitimation entity. The legitimation entity is preferably realized as a trustworthy entity. In particular, the public key of the entity is freely available/viewable. In particular, by checking a match of the publicly retrievable public key and the content of the publicly viewable NFT that is owned by the legitimation entity, the authenticity of the public key is confirmed (match present) or refuted (match not present).

In addition, it is proposed that the NFT is offered for transmission to at least one legitimation entity that is different from the entity, for example on a digital NFT marketplace, directly or in a private predefined circle. This advantageously allows ensuring simple implementation of the verification method. In particular, the NFT created by the entity itself is offered to the legitimation entity in one of the proposed ways. In particular, the legitimation entity or further entities can send (directly or via the digital NFT marketplace) at least one transaction request to the entity that requests the entity to transmit the NFT.

It is further proposed that the legitimation entity that is different from the entity requests transmission of the NFT, whereupon the NFT, preferably the requested NFT, is sent from a DLT owner address of the entity to a DLT owner address of the legitimation entity that is different from the entity. This advantageously allows ensuring simple implementation of the verification method. Advantageously simple public verification of the public key is enabled. After transmission of the NFT to the DLT owner address of the legitimation entity, any person can check in a simple manner—by querying the DLT owner address of the legitimation entity—whether the public key of the entity is registered there by means of the NFT, respectively whether the NFT containing the public key or its derivative is owned by the legitimation entity, thus determining, depending on the person's trust in the legitimation entity, whether the public key is trustworthy.

If in such a case at least one NFT received by the legitimation entity, preferably each NFT received each the legitimation entity, is checked in at least one checking step, in particular carried out on the side of the legitimation entity, as to whether the NFT was previously requested by the legitimation entity, wherein in the event of a negative checking result the NFT is directly redeemed or burned, incorrect legitimations can advantageously be prevented. This advantageously allows achieving high security of the verification and/or a high confidence level of the verification. In particular, a negative checking result obtained in the check means that the NFT was sent to the legitimation entity unrequested. In particular, a positive checking result obtained in the check means that the NFT was sent to the legitimation entity after preceding request by the legitimation entity. Upon the redeeming of the NFT, all metadata, links and relationships of the NFT with the physical or digital object (here: the public key) are detached/removed from the NFT. The NFT is thus converted back into the “empty” DLT token which it was before creation (minting). To carry out the redeeming process, the NFT is in particular sent back to a DLT address of the creator of the NFT (e. g. a contract address of a smart contract). In particular, the “empty” DLT token is reusable following the redeeming, that is to say, for example, a new NFT containing a further public key can be created therefrom. Upon the burning, the NFT is in particular sent to a “burn address” of the DLT (e. g. 0x000000000000000000000000000000000000dEaD or 0x0000000000000000000000000000000000000000 for ERC20 token, ERC721 token, ERC1155 token or BEP-20 token). Nobody has access/can ever have access to this “burn address”, such that NFTs sent there are quasi destroyed. In particular, the NFT sent to the “burn address” and its underlying DLT token are removed from the circuit and no longer reusable, that is to say, for example, no new NFT containing a further public key can be created therefrom. Often the total number of DLT tokens is limited, such that the rarity of the DLT tokens is augmented by the burning.

In addition, it is proposed that the public key is verified in at least one verification step by determining ownership of the NFT/the NFTs of the public key. This advantageously enables simple, reliable and secure verification of the public key, in particular by each participant of the DLT. In particular, the ownership of an NFT can be determined by sending a transaction to a smart contract related to the NFT, for example to the smart contract via which the NFT was created, or by querying DLT nodes. The transaction or the query preferably results in an output of a DLT owner address which currently owns the NFT, in particular the DLT token underlying the NFT, respectively which currently has power of disposal over the NFT, in particular the DLT token underlying the NFT. In this way, the ownership of the NFT can advantageously be determined reliably and easily by each participant of the DLT. In particular, the legitimation entity is assigned to the owner address. In particular, exclusively the legitimation entity has power of disposal over the owner address and preferably over all NFTs owned by the owner address. If the legitimation entity is trustworthy, e. g. is embodied by an official entity such as an authority or by a private trustworthy entity such as an IT security company, a KYC (Know Your Customer) provider etc., the fact that this entity owns the NFT with the public key or the deterministic derivative of the public key permits concluding that the public key is genuine. A communication based on the use of the public key can thus be trusted, respectively can be assigned as much trust as the entity that owns the associated NFT. By a burning or redeeming of the NFT by the legitimation entity, the verifiability of respective public keys by the legitimation entity can be ended. This may for example be the case if a paid time interval or a validity of the public key has expired, if a validity of the linked object has expired (e. g. an expiry date of a passport verified by an authority has been reached), etc.

Advantageously, it is proposed that the NFT is provided for the verification of the ownership, in particular within the DLT, for example on a digital NFT marketplace, directly or in a private predefined circle. This advantageously enables simple and reliable verification of the public key. In particular, the NFT suitable for the respective public key can be determined/provided in this way. Herein the digital marketplace may be publicly accessible or access-restricted, e.g. by a central authority which checks who is allowed to offer and/or retrieve which kind of NFTs.

Furthermore, it is proposed that, for a cancelation of the legitimation of the entity by the legitimation entity, the NFT is sent to the burn address of the DLT or to a DLT address of a developer/administrator of the DLT, in particular to the DLT address of the smart contract originally used for creating the NFT. This advantageously enables simple and/or publicly traceable cancelation of the legitimation. Alternatively, for a cancelation of the legitimation of the entity by the legitimation entity, the NFT can also be sent to a further DLT address that differs from the DLT address of the legitimation entity. It is herein decisive that the NFT is then demonstrably no longer owned by the legitimation entity.

It is proposed that at least the creation (minting) of the NFT, at least a transaction of the NFT, at least a verification of the NFT, at least a redeeming of the NTF and/or at least a burning of the NFT is implemented by an execution of one or several smart contracts of the DLT or by a direct creation as a native asset of the DLT. A “smart contract” is in particular to mean a contract placed on a DLT, which comprises at least one, preferably a plurality of if/then conditions as preprogrammed functions that can be called up. For this purpose, in particular “if” conditions are provided to the smart contract as input, and the smart contract responds by an output/non-output of “then” results. In particular, the smart contract is realized as a software code placed on the DLT. In particular, the smart contract is realized so as to be unchangeable by the placing on the DLT. In particular, the smart contract is assigned a DLT address in the DLT. In particular, the smart contract can be called up by sending transactions to the DLT address of the smart contract. In particular, an execution of the smart contract requires payment of a fee, which is added in the form of DLT tokens to the transactions calling up the smart contract. In particular, the smart contract is executed after calling up more than one DLT node (“quorum”), wherein an output of the result only takes place if all members of the quorum arrive at the same result. Preferably, the smart contract, which is used at least for the creation of the NFT, comprises at least one of the following functions, preferably at least the following functions: mintToken (for creating an NFT from the underlying DLT token and for sending this NFT to a DLT address), tokenOwner (for outputting the DLT owner address of an NFT), tokenBalance (for outputting all NFTs of a specific DLT owner address), burnToken (for burning an NFT, i.e. for sending the NFT to the burn address), redeemToken (for redeeming the NFT, i. e. for detaching the link to the physical or digital object and for sending the DLT token underlying the NFT back to the DLT address of the smart contract), tokenTransfer (for sending the NFT to another DLT address) and approveTransfer (for accepting a requested shipping of the NFT to a DLT address).

Furthermore, the creation of the NFT by means of the smart contract will be described below by way of example. In particular, the process of the NFT creation according to the invention is also called minting in the technical language. In the minting of an NFT that is linked to a physical or digital object, a digital asset of the DLT, e.g. a DLT token, is converted into the NFT according to the invention by adding metadata (here: public key or its deterministic derivative) to the DLT token. For this purpose, in particular the metadata are sent to the DLT address of the smart contract together with information regarding which functions of the smart contract are to be called up with which parameters. Preferably, the smart contract thereupon performs the following steps: a) verifying the existence of the functions in the smart contract that are to be called up according to the received information, if applicable with a plausibility check of the parameters, b) verifying whether sufficient fees were received in the form of DLT tokens, possible surplus fees being assigned to the NFT as value, c) preparing a transaction to a DLT address of the DLT network, in particular to the DLT address from which the smart contract was called up, wherein the transaction comprises the NFT linked to the metadata, and d) executing the transaction of the NFT. In particular, then the DLT address to which the transaction was directed is the DLT owner address of the newly minted NFT. The DLT owner address is assigned to the entity that knows/owns the private key assigned to the DLT address (generally itself a public key of the DLT, e.g. 0xEfcA6C6981a448388780cbfefA72dc77C3F73e6b). As a result, the entity is able to send all DLT tokens, NFTs, etc. assigned to the DLT owner address within the DLT.

If the verification step is performed by a web application, such as a web browser, it is for example advantageously possible to establish a secure Internet connection, in particular without the use of certificates. In particular, for this purpose a web server creates a public key-private key pair for secure communication. In particular, the web server generates in the verification step, preferably by means of the smart contract, at least one NFT containing the created public key or its deterministic derivative. A legitimation entity can now take ownership of/purchase the NFT, in particular after the authenticity of the web server has been checked, for example by challenge-response authentication. Now, if the web server is dialed by means of the web application, for example by means of the web browser, the web application can check whether an NFT of the public key offered by the web server is owned by a trustworthy legitimation entity. For this purpose, the web server may for example retrieve a list of trustworthy legitimation entities and may in addition search the DLT addresses of these legitimation entities for the NFT of the public key offered by the web server. If the NFT is found at a trustworthy legitimation entity, the web application can trust the web server and may for example initiate an end-to-end encrypted communication. Advantageously, the legitimation entity does not even have to be online or accessible for successful performance of this process after it has taken possession of the NFT, in particular since all necessary information is then already present in the DLT.

Alternatively or additionally, it is proposed that the entity is realized as a product and that the verification step is performed by a user, purchaser or provider of the product. This advantageously allows achieving high forgery security. The products may now be equipped with public key-private key pairs. Subsequently, the products may then create and/or publish NFTs, which in each case contain the created public key or its deterministic derivative. Herein the products may either themselves have access to the DLT or they may, in a production step, e.g. in an end-of-line check, initiate an NFT creation by an external device, e.g. by the checking device of the end-of-line check after successful checking. A legitimation entity can now take possession of/purchase the NFT. The user, purchaser or provider can now verify the authenticity of the product by first performing a simple challenge-response authentication using the public key, which is known to him and allegedly assigned to the product, for checking whether the private key is actually owned by the product. If this is successful, the user, purchaser or provider may then check whether an NFT of the public key assigned to the product is owned by a trustworthy legitimation entity. This can be done in a similar way as in the web server. If the NFT is found at a trustworthy legitimation entity, the user, purchaser or provider can assume authenticity of his product. The same method can also be used for securing data communication with the product if the product is capable of such communication.

If the legitimation entity is an, in particular digital, central (online) certification authority, certification can advantageously be replaced by certificates and simplified. Advantageously, an interruption of the online connection of the (online) certification authority will not generate a failure of the verification capacity of the (online) certification authority.

If, alternatively or additionally, the entity is realized as a product and the legitimation entity is a manufacturer of the product, verification of original components is advantageously enabled. In particular, the manufacturer of the product may additionally include further properties of the product in the NFT using the proposed method, for example construction year, serial number, etc., which can then also be read out and verified in the verification method.

If, alternatively or additionally, the entity is realized as a product and the legitimation entity is a product checking point or a repair and/or maintenance point for the product, it is advantageously possible to verify whether the product, e. g. the replacement part or the like, has been tested successfully or whether/when the product was correctly repaired and/or maintained.

If, alternatively or additionally, the entity is a person and the legitimation entity is a body legitimized for an identity check of the person, such as an authority or an KYC provider, an identity of the person can advantageously be verified in a secure and reliable manner. Persons to whom e. g. a decentralized identifier DID or another digital identity is assigned (e. g. via an electronic identity card or by an electronic passport) can create NFTs according to the invention therefrom/have NFTs according to the invention created therefrom. This may be done, for example, with the aid of an authority/a KYC provider. The legitimation entity, e. g. the authority or the KYC provider, can now, e. g. on site, verify an identity of a person and take ownership of/purchase the NFT of the person. If now the identity of the person is to be checked, the DLT owner address of the legitimation entity, e. g. of the authority/of the KYC provider, can be searched for suitable NFTs in a manner similar to the methods described above. A presence of the NFT at the legitimation entity verifies the identity of the person. The authenticity of the public key that is to be checked can also be confirmed in advance by challenge-response authentication or the like of the object that memorizes the DID or the digital identity (e. g. passport, driver's license, residence permit, etc.). It is also conceivable that the legitimation entity, e. g. the authority or the KYC provider, packs zero-knowledge evidence into the NFTs together with the public keys, creates them itself and takes ownership of them immediately.

Furthermore, it is proposed that the NFT created in the method step contains in addition to the public key, or in particular also instead of the public key, at least a confirmation, for example a warranty certificate, an insurance confirmation, a use permit certificate, or its deterministic derivative, and/or at least an expiry date, for example a warranty expiry, an insurance period, a duration of a use permit, which is assigned to the entity or to an agreement connected to the entity. As a result, a characteristic of the entity can advantageously be read out by anyone in an unfalsifiable manner. It is conceivable that, e. g. by a manufacturer of the product, an NFT is created which comprises the public key assigned to the product and the confirmation or its deterministic derivative and/or the expiry date. This NFT can then be taken into ownership by an end user of the product, i. e. sent to a DLT address of the end user. In this case, the end user realizes an alternative legitimation entity. The manufacturer can in this case advantageously determine, by querying the DLT address of the end user, whether the respective end user actually owns the product. With ownership of the product verified in this way, advantageously then grant of a service, such as for example a (cost-free) repair, maintenance, warranty or another service, can be linked. By the additionally included expiry date, a time limitation of the promised service can advantageously be publicly and unfalsifiably viewable and verifiable.

In particular, it is also conceivable that a third party, for example an insurance, takes ownership of an NFT that comprises at least the public key of a product or of a person, wherein the presence of an insurance for the person or the product is confirmed by the ownership. As long as the NFT is owned by the third party (the insurance), the insurance is active, which can be viewed by anyone in an unfalsifiable, simple and secure manner by querying the DLT owner address of the third party (the insurance). As soon as the third party (the insurance) sends the NFT to a further address, either the insurance changes (shipping to another third party) or the insurance protection expires (redeeming or burning of the NFT). In particular, the NFT may also include the insurance conditions, which are thus advantageously stipulated in an unfalsifiable manner.

Beyond this, it is proposed that the entity is a person with a digital ID and/or a decentralized identifier (DID) comprising a private key/public key pair, and that the NFT created/minted in the method step additionally contains at least one legitimation of the person, for example an identity document, a driving license, a residence permit, etc., or a deterministic derivative thereof. This advantageously enables simple, secure and/or unfalsifiable verification of personal identities. In particular, the authenticity of the respective legitimation of the person can be confirmed, by the ownership of the NFT, by the legitimation entity realized in this case exemplarily as an authority.

Moreover, it is proposed that the NFT created/minted in the method step additionally contains at least an ownership confirmation, for example a training diploma, a stock portfolio, an ownership certificate for things or real estate etc., or a deterministic derivative thereof. This advantageously allows making an allocation of the ownership confirmation to a person verifiable in an easy, secure and/or unfalsifiable manner. In particular, the authenticity of the respective ownership of a person's property can be confirmed, by the ownership of the NFT, by the respective legitimation entity. If, for example, the land registry office contains an NFT assigned to a person P, which furthermore comprises an ownership confirmation regarding a piece of land G, the ownership relation can advantageously be verified for anyone by querying the DLT owner address of the land registry office. In particular, in this case and other cases, in order to enable verification by a third party, the third party's knowledge of an NFT identifier, e. g. a running mint number of the NFT, may be required.

Furthermore, a verification computer system, which is in particular configured for carrying out a verification method, with at least one NFT creation device that is configured for creating/minting an NFT containing a copy of a public key, assigned to an entity, of an asymmetric cryptography system or a deterministic derivative of the public key, and is configured for storing the created NFT in a distributed ledger, such as a blockchain, a tangle or a hashgraph, of a distributed ledger technology (DLT). This advantageously enables simple and at the same time secure verification of an authenticity of the public key. In particular, the verification computer system comprises at least one server or a plurality of servers linked in terms of network technology. In particular, the DLT is distributed over a plurality of preferably public and/or decentralized nodes, wherein each node comprises at least one dedicated computer with at least one processor and with a memory. The NFT creation device may be realized, for example, as a mobile computer, e. g. a smartphone of a person, or as a stationary computer system, e. g. an authority server, an enterprise server or a server in a product manufacturing line. The NFT creation device in particular comprises a processor, a memory and a (pre-installed) computer program that is stored in the memory and is specifically designed for executing at least the method step of the afore-described verification method in which the NFT is created.

In addition, it is proposed that the verification computer system comprises a verification device, which is in particular realized separately from the NFT creation device, and which is configured for checking an authenticity of the public key by querying and evaluating an ownership status of the NFT. This advantageously enables simple and at the same time secure verification of an authenticity of the public key. The verification device may be realized, for example, as a mobile computer, e.g. a smartphone of a person, or as a stationary computer system, e.g. an authority server, a personal computer, an enterprise server or a server in a product manufacturing line. The verification device in particular comprises a processor, a memory and a (pre-installed) computer program, which is stored in the memory and is specifically designed for executing at least the verification step in which the ownership status of the NFT is determined.

It is further proposed that the verification computer system comprises a legitimation device, which is in particular realized separately from the NFT creation device and from the verification device, and which is configured to take possession of/purchase the NFT via a publicly viewable legitimation address of the DLT that can be allocated to a legitimation entity. This advantageously enables simple and at the same time secure verification of an authenticity of the public key. The legitimation device may be realized, for example, as a mobile computer, e.g. a smartphone of a person, or as a stationary computer system, e.g. an authority server, a personal computer, an enterprise server or a server in a product manufacturing line. The legitimation device in particular comprises a processor, a memory and a (pre-installed) computer program, which is stored in the memory and is specifically designed for querying at least the NFT in the DLT as well as for controlling and managing a DLT owner address to which the NFTs are sent, respectively for enabling control and/or management of the NFT for an operator of the legitimation device. Preferably, the (pre-installed) computer program stored in the memory of the legitimation device is configured to execute the checking step, preferably in an automated manner. Furthermore, the NFT creation device and the verification device are proposed.

The verification method according to the invention and the verification computer system according to the invention shall here not be limited to the above-described application and implementation. In particular, in order to fulfil a functionality that is described here, the verification method according to the invention and the verification computer system according to the invention may comprise a number of individual elements, components and units that differs from a number given here.

### DRAWINGS

Further advantages will become apparent from the following description of the drawings. An exemplary embodiment of the invention is illustrated in the drawings. The drawings, the description and the claims contain a plurality of features in combination. Someone skilled in the art will purposefully also consider the features individually and will find further expedient combinations.

In the drawings:

FIG. 1 shows a schematic illustration of a verification computer system configured for carrying out a computer-implemented verification method in an asymmetric cryptography system, and

FIG. 2 shows a schematic flow chart of the computer-implemented verification method in the asymmetric cryptography system.

### DESCRIPTION OF THE EXEMPLARY EMBODIMENT

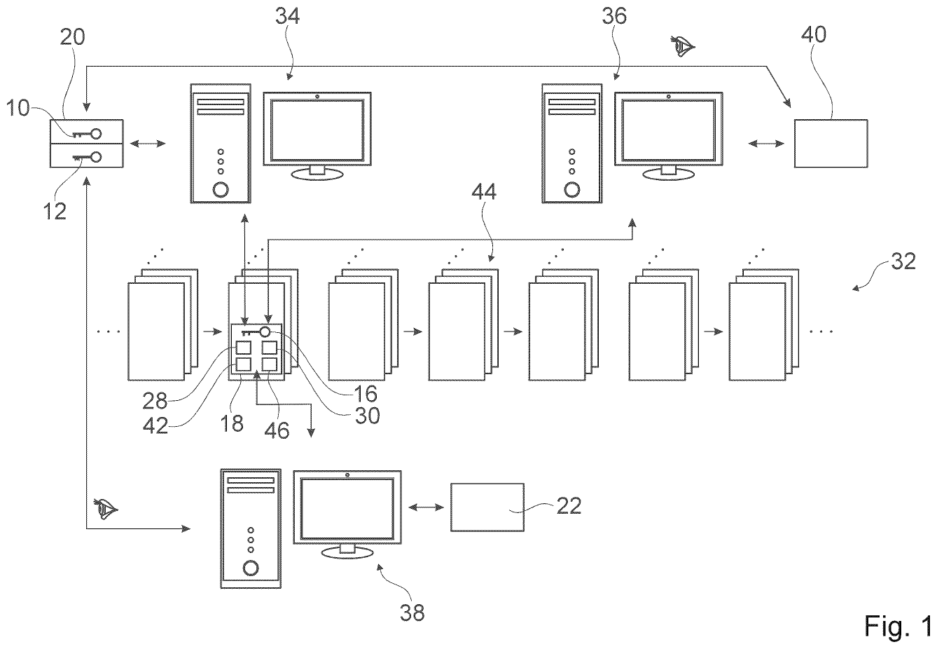

FIG. 1 schematically shows an exemplary verification computer system 32, which is configured for carrying out a verification method. The verification computer system 32 comprises an NFT creation device 34. The NFT creation device 34 is configured for creating a non-fungible token (NFT 18) for an entity 20. A public key 10 of an asymmetric cryptography system is assigned to the entity 20. The entity 20 may in this case be realized as a physical or digital object (product) or as a person. The public key 10 is publicly retrievable/viewable. A private key 12 of the asymmetric cryptography system is assigned to the entity 20. The private key 12 and the public key 10 of the entity 20 form a public key-private key pair of the asymmetric cryptography system. The NFT creation device 34 can view/determine the public key 10 of the entity 20. The NFT creation device 34 is configured for checking the allocation of the public key 10 to the entity 20 before the creation of the NFT 18, e. g. by challenge-response authentication. The NFT 18 created by the NFT creation device 34 contains a copy of the public key 16, assigned to the entity 20, of the asymmetric cryptography system. Alternatively, the NFT 18 may also contain a deterministic derivative of the public key 10 instead of the copy of the public key 16. The NFT creation device 34 may be a (mobile or stationary) computer of the entity 20 or a computer of a further entity that is different from the entity 20, such as for example of an authority. The NFT creation device 34 is configured for storing the created NFT 18 in a distributed ledger, such as a blockchain, a tangle or a hashgraph, of a distributed ledger technology (DLT) 44. The DLT 44 is realized as a decentralized DLT. Alternatively, however, centralized or partially centralized DLTs are also conceivable. The NFT 18 is offered via the DLT 44 for transmission to legitimation entities 22 that differ from the entity 20. The legitimation entity 22 may be realized inter alia as a central certification authority, as an authority, as a KYC provider, as a product manufacturer, as a product checking point, as a repair point, as a maintenance point, as an insurer. The NFT 18 is publicly provided via the DLT 44 for verification of the ownership. In addition to the public key 10, the NFT 18 may also include further information or the like, e. g. a confirmation 28, an expiry date 30, a legitimation 42 of a person, an ownership title 46 of a person or their respective deterministic derivatives.

The verification computer system 32 comprises a legitimation device 38. The legitimation device 38 is realized separately from the NFT creation device 34. The legitimation device 38 is configured to purchase/take possession of the NFT 18 via a publicly viewable legitimation address of the DLT 44 (DLT address of the legitimation entity 22) that can be allocated to a legitimation entity 22. The legitimation device 38 can view/determine the public key 10 of the entity 20. The legitimation device 38 is configured for checking an authenticity of the public key 10 by querying and evaluating an ownership status of the NFT 18. The legitimation device 38 is configured for checking the allocation of the public key 10 to the entity 20, e. g. by challenge-response authentication, before the NFT 18 is taken possession of. The legitimation device 38 publicly provides the NFT 18 via the DLT 44 for the verification of the ownership. The legitimation device 38 is configured to enable the legitimation entity 22 to request transmission of the NFT 18. The legitimation device 38 is configured to enable the legitimation entity 22 to receive/take possession of the requested NFT 18. A DLT owner address of the legitimation entity 22 is assigned to the legitimation entity 22/the legitimation device 38. The legitimation device 38 is configured for checking each NFT 18 received by the legitimation entity 22 as to whether the NFT 18 was previously requested by the legitimation entity 22/by the legitimation device 38, wherein in the event of a negative checking result the NFT 18 is directly redeemed or burned. Alternatively, in the event of a negative checking result the NFT 18 can also be sent back to a DLT sender address. The legitimation device 22 is configured, for a cancelation of the legitimation of the entity 20 by the legitimation entity 22, to burn the NFT 18, i. e. to send it to a burn address of the DLT 44, or to redeem it, i. e. to send it to a DLT address of a developer/administrator of the DLT 44, in particular to a DLT address of the smart contract originally used for creating the NFT 18.

The verification computer system 32 comprises a verification device 36. The verification device 36 is realized separately from the NFT creation device 34. The verification device 36 is realized separately from the legitimation device 38. The verification device 36 can view/determine the public key 10 of the entity 20. The verification device 36 is configured for checking an authenticity of the public key 10 by querying and evaluating an ownership status of the NFT 18. The verification device 36 is configured for checking the allocation of the public key 10 to the entity 20 before a check of the authenticity of the public key 10 by querying and evaluating the ownership status of the NFT 18, e. g. by challenge-response authentication. The verification device 36 may be assigned to any further entity 40 that is different from the entity 20, for example a private person, a company or an authority.

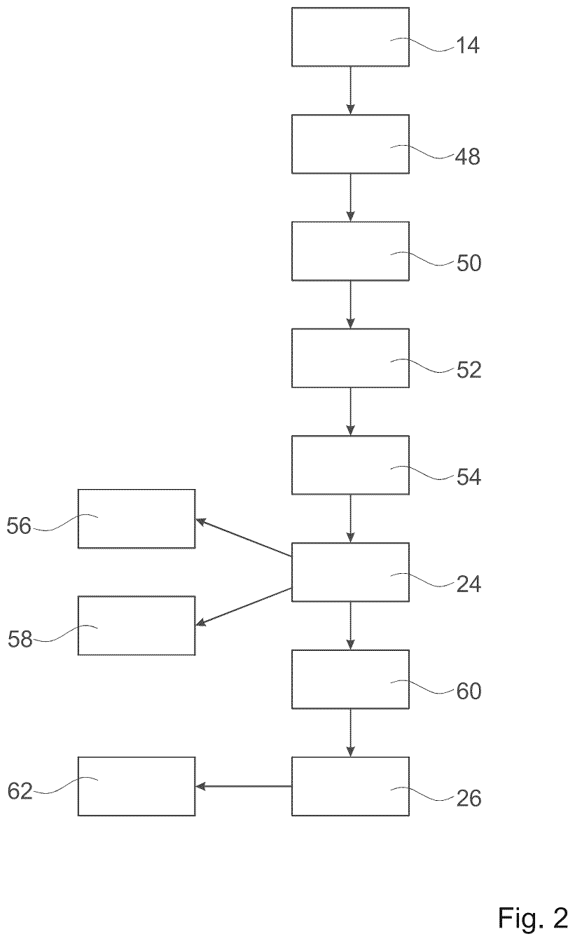

FIG. 2 shows a schematic flow chart of a computer-implemented verification method in an asymmetric cryptography system with at least the entity 20 which the public key 10 and the private key 12 are assigned to. In at least one method step 14, the NFT 18 is created (minted) which contains the copy of the public key 16 or the deterministic derivative of the public key 10. In the method step 14, the NFT 18 is stored in the distributed ledger, such as a blockchain, a tangle or a hashgraph, of the DLT 44. The creation of the NFT 18 takes place by an execution at least of a smart contract of the DLT 44. Alternatively, a creation of the NFT 18 as a native asset of the DLT 44 may be considered. When created, the NFT 18 created in the method step 14 is in a further method step 48 sent from the smart contract to a DLT address, preferably to the DLT address of the device that initiated the NTF creation, e. g. the NFT creation device 34 of the entity 20 or an NFT creation device 34 of an authority.

The NFT 18 created in the method step 14 may include, in addition to the public key 10, at least a confirmation 28 or its deterministic derivative, which is assigned to the entity 20 or to an agreement connected to the entity 20. The confirmation 28 may, for example, be a warranty certificate, an insurance confirmation, a use permit certificate or the like. The NFT 18 created in the method step 14 may include, in addition to the public key 10, at least an expiry date 30, which is assigned to the entity 20 or to an agreement connected to the entity 20. The expiry date 30 may, for example, be a warranty expiry, an insurance period, a duration of a use permit or the like.

If the entity 20 is a person with a digital ID and/or a decentralized identifier (DID), comprising a private key-public key pair, the NFT 18 created in the method step 14 may contain, in addition to the public key 10, at least a legitimation 42 of the person. The legitimation 42 of the person may be, for example, an identity document, a driving license, a residence permit etc., or a deterministic derivative thereof. Alternatively or additionally, the NFT 18 created in the method step 14 may contain, in addition to the public key 10, at least an ownership confirmation 46. The ownership confirmation 46 may, for example, be a training diploma, a stock portfolio, an ownership certificate for things or real estate etc., or a deterministic derivative thereof.

In at least one further method step 50, the NFT 18 is offered for transmission to at least one legitimation entity 22 that is different from the entity 20. This offer may take place, for example, via a public or access-restricted marketplace. In at least one further method step 52, the legitimation entity 22 that is different from the entity 20 requests transmission of the NFT 18. For this purpose, the legitimation entity 22 can send a transaction query to the current DLT owner address of the NFT 18 via the DLT 44. In at least one method step 54, the requested NFT 18 is sent to a DLT address of the legitimation entity 22 via the DLT 44. For this purpose, the device that is assigned the DLT address to which the legitimation entity 22 has sent the transaction request in the method step 52 can accept (sign) the transaction request. Authenticity of the public key 10 can then be confirmed by determining whether the NFT 18 is owned by a trustworthy legitimation entity 22 that is different from the entity 20. The NFT 18 is owned by the trustworthy legitimation entity 22 if it is under control of the DLT address assigned to the trustworthy legitimation entity 22. In this case, only the legitimation entity 22 knows a private key of this DLT address, which is required to have power of disposal over the NFT 18. Such a trustworthy legitimation entity 22 may be a central certification authority. Such a trustworthy legitimation entity 22 may be a product manufacturer. Such a trustworthy legitimation entity 22 may be a product checking point. Such a trustworthy legitimation entity 22 may be a repair point. Such a trustworthy legitimation entity 22 may be a maintenance point. Such a trustworthy legitimation entity 22 may be an authority. Such a trustworthy legitimation entity 22 may be a KYC provider.

In at least one checking step 24, each NFT 18 received by the legitimation entity 22 is checked as to whether the NFT 18 was previously requested by the legitimation entity 22 in the method step 52. In the event of a negative checking result from the checking step 24, the NFT 18 is directly redeemed in a further method step 56. In an alternative further method step 58, in the event of a negative checking result from the checking step 24, the NFT 18 is burned. In at least one method step 60, the NFT 18 is publicly provided by the legitimation entity 22 for the verification of the ownership. Herein the NFT 18 is assigned to a publicly queryable DLT owner address that is bijectively allocatable to the legitimation entity 22. In at least one verification step 26, the public key 10 is verified. In the verification step 26, ownership of the NFT 18 is determined via the public key 10. The ownership is determined by a query in the DLT 44. In the determination of the ownership, the DLT owner address is determined which currently has power of disposal over the NFT 18. The verification step 26 may be performed by a web application, like for example a web browser. The verification step 26 may be performed by a user, purchaser or provider of an entity 20 that is realized as a product.

In the verification step 26, in addition to the verification of the public key 10, further information contained in the NFT 18 may also be read out, such as the confirmation 28, the expiry date 30, the legitimation 42 and/or the ownership confirmation 46.

In at least one further method step 62, for a cancelation of the legitimation of the entity 20 by the legitimation entity 22, the NFT 18 is sent from the DLT owner address that can be allocated to the legitimation entity 22 to a burn address of the DLT 44. Alternatively, the NFT 18 can be sent from the DLT owner address that is allocatable to the legitimation entity 22 to a DLT address of a developer/administrator of the DLT 44, in particular to a DLT address of the smart contract originally used for creating the NFT 18. Alternatively, the NFT 18 can be sent/sent back from the DLT owner address that is allocatable to the legitimation entity 22 to a further DLT address, e. g. to the DLT address of the entity 20.

1. A verification method, in particular a computer-implemented verification method, in an asymmetric cryptography system with at least one entity to which a public key and a private key are assigned, wherein in at least one method step at least one non-fungible token is created which contains a copy of the public key or a deterministic derivative of the public key and which is stored in a distributed ledger, such as a blockchain, a tangle or a hashgraph, of a distributed ledger technology.

2. The verification method according to claim 1, wherein authenticity of the public key is confirmed in that the NFT is owned by at least one legitimation entity that is different from the entity.

3. The verification method according to claim 1, wherein the NFT is offered for transmission to at least one legitimation entity that is different from the entity.

4. The verification method according to claim 1, wherein at least one legitimation entity that is different from the entity requests transmission of the NFT and/or that wherein the NFT, preferably the requested NFT, is sent to at least one legitimation entity that is different from the entity.

5. The verification method according to claim 4, wherein at least one NFT received by the legitimation entity, preferably each NFT received by the legitimation entity, is checked in at least one checking step as to whether the NFT was previously requested by the legitimation entity, wherein in the event of a negative checking result the NFT is directly redeemed or burned.

6. The verification method according to claim 2, wherein in at least one verification step the public key is verified by determining ownership of the NFT/of the NFTs of the public key.

7. The verification method according to claim 6, wherein the NFT is provided for verification of the ownership.

8. The verification method at least according to claim 2, wherein for a cancelation of the legitimation of the entity by the legitimation entity, the NFT is sent to a burn address of the DLT or to a DLT address of a developer/administrator of the DLT, in particular to a DLT address of the smart contract originally used for creating the NFT.

9. The verification method according to claim 6, wherein the verification step is performed by a web application, like for example a web browser.

10. The verification method according to claim 6, wherein the entity is realized as a product and the verification step is performed by a user, purchaser or provider of the product.

11. The verification method at least according to claim 2, wherein the legitimation entity is a central certification authority.

12. The verification method at least according to claim 2, wherein the entity is realized as a product and the legitimation entity is a manufacturer of the product.

13. The verification method at least according to claim 2, wherein the entity is realized as a product and the legitimation entity is a product checking point or a repair point and/or a maintenance point for the product.

14. The verification method according to claim 2, wherein the entity is a person and the legitimation entity is a body legitimized for an identity check of the person, like an authority or a KYC provider.

15. The verification method according to claim 1, wherein the NFT created in the method step contains in addition to the public key at least a confirmation, for example a warranty certificate, an insurance confirmation, a use permit certificate, or its deterministic derivative, and/or at least an expiry date, for example a warranty expiry, an insurance period, a duration of a use permit, which is assigned to the entity or to an agreement connected to the entity.

16. The verification method according to claim 1, wherein the entity is a person with a digital ID and/or a decentralized identifier, comprising a private key-public key pair, and the NFT created in the method step further contains at least a legitimation of the person, for example an identity document, a driving license, a residence permit etc., or a deterministic derivative thereof.

17. The verification method according to claim 1, wherein the entity is a person with a digital ID and/or a decentralized identifier, comprising a private key-public key pair, and the NFT created in the method step additionally contains at least an ownership confirmation, for example a training diploma, a stock portfolio, an ownership certificate for things or real estate etc., or a deterministic derivative thereof.

18. A verification computer system, which is in particular configured for carrying out a verification method according to claim 1, with at least one NFT creation device that is configured to create an NFT containing a copy of a public key, assigned to an entity, of an asymmetric cryptography system or a deterministic derivative of the public key, and is configured for storing the created NFT in a distributed ledger, such as a blockchain, a tangle or a hashgraph, of a distributed ledger technology.

19. The verification computer system according to claim 18, further comprising a verification device, which is in particular realized separately from the NFT creation device, and which is configured for checking an authenticity of the public key by querying and evaluating an ownership status of the NFT.

20. The verification computer system according to claim 18, further comprising a legitimation device, which is in particular realized separately from the NFT creation device and from the verification device, and which is configured for taking possession of/purchasing the NFT via a publicly viewable legitimation address of the DLT that can be allocated to a legitimation entity.

21. An NFT creation device of the verification computer system according to claim 18.

22. The verification device of the verification computer system according to claim 19.
